(19) United States
(12) Patent Application Publication
(10) Pub. No.: US 2025/0353652 A1
(43) Pub. Date: Nov. 20, 2025

(54) LOW ASPECT-RATIO PALLETIZED FAN-FOLDED STOCK MATERIAL

(71) Applicant: Pregis LLC, Chicago, IL (US)

(72) Inventor: Thomas D. Wetsch, Naples, FL (US)

(21) Appl. No.: 19/213,675

(22) Filed: May 20, 2025

Related U.S. Application Data
(60) Provisional application No. 63/649,616, filed on May 20, 2024.

(51) Int. Cl. B65D 71/00; B31D 5/00; B65D 85/62

(52) U.S. Cl. CPC B65D 71/0096; B31D 5/0052; B65D 85/62; B31D 2205/0035; B31D 2205/0047; B65D 2571/00012; B65D 2571/00061

(57) ABSTRACT

Palletized units of fan-folded stock material include a pallet having a deck configured to support the fan-folded stock material, and a stack of the stock material supportively positioned on the deck. The stock material includes an elongated web of sheet material configuration defined by folds in the web about fold lines that extend in a transverse direction of the web that segment the web into a plurality of sheet sections, with adjacent sheet sections folded onto one another.

### CROSS-REFERENCE TO RELATED APPLICATIONS

This application claims the benefit under 35 U.S.C. § 119 (e) of U.S. Provisional Patent Application No. 63/649,616, filed May 20, 2024, the contents of which are incorporated by reference herein in their entirety.

### BACKGROUND

Paper-based protective packaging, or dunnage, can be produced by running a generally continuous strip of paper through a dunnage conversion machine. The continuous strip of paper often is provided from a fan-fold stack of paper. The fan-fold stacks typically are supplied on pallets. The length and/or width of the stacks can be substantially smaller than the respective length and/or width of the pallets on which the stacks are placed. Thus, two or more of the stacks usually are placed side-by-side or end-to-end on a single pallet. The placement of multiple stacks on a single pallet can necessitate connecting the stacks to each other by, for example, daisy chaining, so that the paper can be drawn sequentially from the stacks by the dunnage conversion machine. The need to connect the stacks can increase the time and effort required to assemble the loaded pallet.

### SUMMARY

In one aspect of the disclosed technology, a palletized unit of fan-folded stock material includes a pallet that includes a deck configured to support the fan-folded stock material, the deck having a deck length and a deck width. The palletized unit also includes a first stack of the stock material supportively positioned on the deck. The stock material includes an elongated web of sheet material configuration defined by folds in the web about fold lines that extend in a transverse direction of the web that segment the web into a plurality of sheet sections, with adjacent sheet sections folded onto one another.

The first stack has a transverse stack width measured in a transverse direction coinciding with the transverse direction of the stack, a stack length measured in a lengthwise direction coinciding with a longitudinal spacing between sequential folds, and a stack depth coinciding with a direction in which the sheet sections are stacked on one another. The first stack is positioned on the deck with the stack length and stack width generally aligned with the deck length and the deck width, respectively, and the stack length is about equal to or greater than 70% of the deck length.

In another aspect of the disclosed technology, the stack length is greater than 70% of the deck length and less than 110% of the deck length.

In another aspect of the disclosed technology, the stack length is greater than 90% of the deck length and less than 100% of the deck length.

In another aspect of the disclosed technology, the stack length is about equal to or greater than 80% of the deck length.

In another aspect of the disclosed technology, the stack length is about equal to or greater than 100% of the deck length.

In another aspect of the disclosed technology, the first stack has an aspect ratio of the stack width to the stack length, which aspect ratio is less than about 3:2.

In another aspect of the disclosed technology, the aspect ratio of the stack width to the stack length is between about 1:2 and about 3:2.

In another aspect of the disclosed technology, the deck width and the deck length are within about five percent of each other.

In another aspect of the disclosed technology, the stock material is paper.

In another aspect of the disclosed technology, the elongated web of sheet material includes a first ply and a second ply of the stock material superimposed on each other so that each of the folds in the first ply corresponds to a respective fold in the second ply.

In another aspect of the disclosed technology, a basis weight of the first ply is different than a basis weight of the second ply.

In another aspect of the disclosed technology, the first ply has slits formed therein.

In another aspect of the disclosed technology, the second ply has slits formed therein.

In another aspect of the disclosed technology, a size, an orientation, and/or a pattern of the slits in the first ply are different than a size, an orientation, and/or a pattern of the slits in the second ply.

In another aspect of the disclosed technology, each of the plurality of sheet sections includes a portion of the first ply and a portion of the second ply in an interleaved arrangement.

In another aspect of the disclosed technology, the deck is an upper deck of the pallet, and the pallet further includes a plurality of stringers, and a lower deck. The upper deck is mounted on the stringers; the lower deck is connected to the stringers so that the stringers are positioned between the upper deck and the lower deck; and notches are formed in outermost ones of the stingers to facilitate entry of the forks of a forklift between the upper deck and the lower deck.

In another aspect of the disclosed technology, the palletized unit further includes one or more ties wrapped around the first stack and secured to the pallet, a cover positioned over the first stack, and/or a tray positioned between the deck and the first stack.

In another aspect of the disclosed technology, the palletized unit further includes a protective medium positioned around the first stack.

In another aspect of the disclosed technology, the protective medium includes stretch film, shrink wrap, and/or corrugated cardboard.

In another aspect of the disclosed technology, the stack depth is greater than 42 inches.

In another aspect of the disclosed technology, the first stack of the stock material is free of splices within the first stack of the stock material.

In another aspect of the disclosed technology, the palletized unit further includes a second stack of the stock material supportively positioned on the deck in a side-by-side relationship with the first stack so that the stack length and stack width of the second stack are generally aligned with the stack length and stack width of the first stack. The web of the second stack is connected to the web of the first stack by a splice between the webs of the first and second stacks.

In another aspect of the disclosed technology, a palletized unit of fan-folded stock material includes a pallet that includes a deck configured to support the fan-folded stock material, the deck having a deck length and a deck width. The palletized unit also includes a first stack of the stock material supportively positioned on the deck. The stock material includes an elongated web of sheet material configuration defined by folds in the web about fold lines that extend in a transverse direction of the web that segment the web into a plurality of sheet sections, with adjacent sheet sections folded onto one another.

The first stack has a stack width coinciding with the transverse direction of the stack; a stack length coinciding with a longitudinal spacing between sequential folds; a stack depth coinciding with a direction in which the sheet sections are stacked on one another; and an aspect ratio of the stack width to the stack length. The first stack is positioned on the deck with the stack length and stack width generally aligned with the deck length and the deck width, respectively. The aspect ratio of the stack width to the stack length is less than about 3:2.

In another aspect of the disclosed technology, the aspect ratio of the stack width to the stack length is about 1:2.

In another aspect of the disclosed technology, the aspect ratio of the stack width to the stack length is between about 1:2 and about 3:2.

In another aspect of the disclosed technology, the deck width and the deck length are within about five percent of each other.

In another aspect of the disclosed technology, the fan-folded stock material is paper.

In another aspect of the disclosed technology, the elongated web of sheet material includes a first and a second ply of the stock material superimposed on each other so that each of the folds in the first ply corresponds to a respective fold in the second ply.

In another aspect of the disclosed technology, a basis weight of the first ply is different than a basis weight of the second ply.

In another aspect of the disclosed technology, each of the plurality of sheet sections includes a portion of the first ply and a portion of the second ply in an interleaved arrangement.

In another aspect of the disclosed technology, the palletized unit further includes a second stack of the stock material supportively positioned on the deck in a side-by-side relationship with the first stack so that the stack length and stack width of the second stack are generally aligned with the stack length and stack width of the first stack. The web of the second stack is connected to the web of the first stack by a splice between the webs of the first and second stacks.

In another aspect of the disclosed technology, a system for converting stock material to dunnage includes the above palletized unit, and a dunnage conversion machine configured to deform the stock material from a first configuration to a lower-density second configuration.

In another aspect of the disclosed technology, the dunnage conversion machine includes a roller configured to deform the stock material.

In another aspect of the disclosed technology, the system further includes a splicing unit configured to form a connection between the first stack of the stock material and a second stack of the stock material.

In another aspect of the disclosed technology, the further includes a positioning device configured to locate the pallet in relation to the dunnage conversion machine.

In another aspect of the disclosed technology, a method for producing dunnage includes providing a palletized unit of fan-folded stock material. The palletized unit of fan-folded stock material includes a pallet that includes a deck configured to support the fan-folded stock material, and a supply of the stock material supportively positioned on the deck. The stock material includes a single elongated web of sheet material configuration defined by folds in the web about fold lines that extend in a transverse direction of the web that segment the web into a plurality of sheet sections, with adjacent sheet sections folded onto one another, the web of sheet material being free of splices.

The method further includes providing a dunnage conversion machine configured to deform the stock material from a first configuration to a lower-density second configuration, and feeding an entirety of the supply of the web of sheet material from the pallet and to the dunnage conversion machine.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a side view of a stacked material unit that includes a low aspect ratio stack of fan-folded stock material;

FIG. 2 is a side view of an alternative embodiment of the stacked material unit shown in FIG. 1;

FIG. 3 is a top-side perspective view of the stacked material unit shown in FIG. 1, depicting the stack of fan-folded stock material with a protective cover, tray, and wrap, and secured to a pallet of the stacked material unit;

FIG. 4 is a side view of a system for converting stock material to dunnage, the system including a splicing unit for connecting two of the stacked material units shown in FIGS. 1-3; and

FIG. 5 is a top-side perspective view of the system shown in FIG. 4.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Protective packaging articles are configured for placement within a packaging container or between packaging containers or items being shipped or stored, to protect items, fill void space within a container, such as a packaging container, and/or prevent or inhibit the items from moving around within the container. While there is overlap between the following categories, example categories of protective packaging articles include protective-fill articles, and block-and-brace articles.

Protective-fill articles are typically provided individually or as a plurality of units that are configured for placing into the void space to provide a desired level of packaging. Such units typically are of a predetermined size or can have a predetermined dimensions and be selectively configurable in another dimension, such as length. In some examples, the size of the protective-fill articles can be configurable in a plurality or all of their dimensions. Protective-fill articles are typically resiliently compressible to around corners, edges, and sides of a packaged item to fill the space around the item, instead of assuming a solid shape that corresponds to the space around the item. Protective-fill articles include, for example, void-fill articles and cushioning articles.

Void-fill articles typically provide minimal cushioning properties and are relatively soft. They are typically used to fill empty void space in packaging containers to reduce the movement within the container of lightweight items that are not delicate, such as a thin book. An example of void-fill includes crumpled-paper dunnage with a fairly weak loft pattern and other space fillers that are easily compressible.

Cushioning articles are configured to provide cushioning to the packaged items and protection to various degrees against shocks and impact. Examples of cushioning materials include inflatable air pillows and cushions, bubble wrap, paper dunnage with a loft structure capable of withstanding moderate shocks and impact, foam sheets, and packing peanuts. Typically, both void-fill and cushioning articles are provided as a plurality of units of one or more similar sizes, typically common predetermined sizes, although in some applications the void-fill or cushioning articles can be made to custom sizes. Some cushioning articles are also packaging containers, such as padded mailers or other containers with a padded wall.

The plurality of void-fill or cushioning articles that are used is typically selected to sufficiently fill the void space within the container to serve the desired protective function. Some void-fill or cushioning articles can be used to enclose or otherwise surround an item, such as expandable-paper or bubble wrap that can be used to wrap an item, such as a bottle.

Paper-based protective packaging, or dunnage, is produced by crumpling or otherwise deforming paper stock. More specifically, paper dunnage is produced by running a generally continuous strip of paper through a dunnage conversion machine. The continuous strip of paper can be provided from, for example, a roll of paper or a fan-fold stack of paper. The dunnage conversion machine converts the paper stock material into a lower density paper dunnage material using, for example, opposing rollers between which the paper stock material is passed. The rollers grip and pull the paper stock material from the roll or stack, and deform the paper stock material as the material passes between the rollers. The resulting paper dunnage can be cut into desired lengths to form individual pieces (or paper cushions or pillows) that can be provided to effectively fill a void space within a container holding a product.

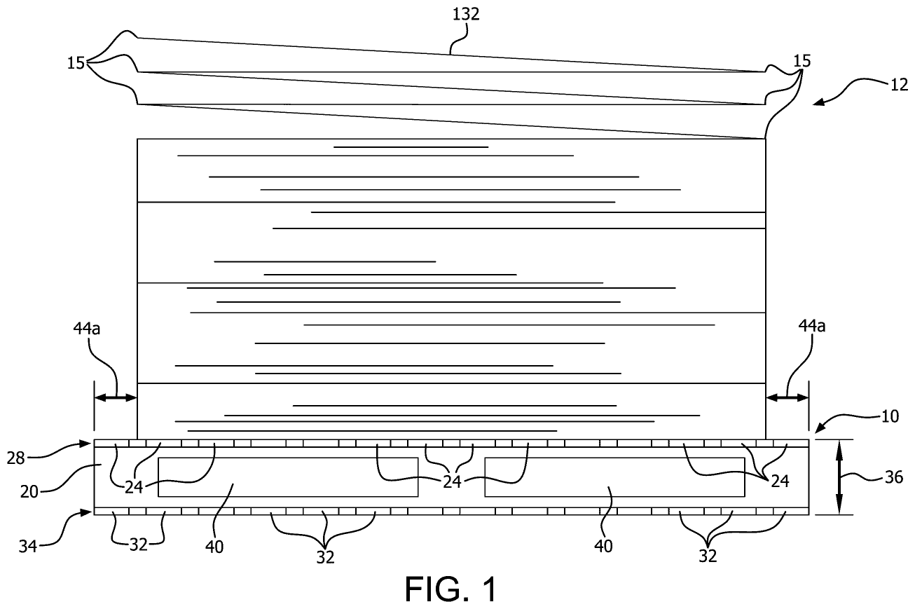

FIG. 1 depicts a pallet 10. The pallet 10 has an upper deck 28. FIG. 1 also depicts a stack 12 of foldable stock material disposed on the upper deck 28 in a fan-folded configuration. The foldable stock material can be, for example, regular kraft paper having a basis weight between 30 lb. (30 lb. per 3,000 square feet) and 90 lb. (90 lb. per 3,000 square feet). In some embodiments, the foldable stock material can be, for example, regular kraft paper having a basis weight of about 50 lb. (50 lb. per 3,000 square feet). The stack 12 can be formed from other types of paper, including extensible paper and paper having basis weights greater than 90 lb. and less than 30 lb.; and other types of foldable materials, such as plastic, foil, etc. The pallet 10 and the stack 12 together form a supply unit of fan-folded paper.

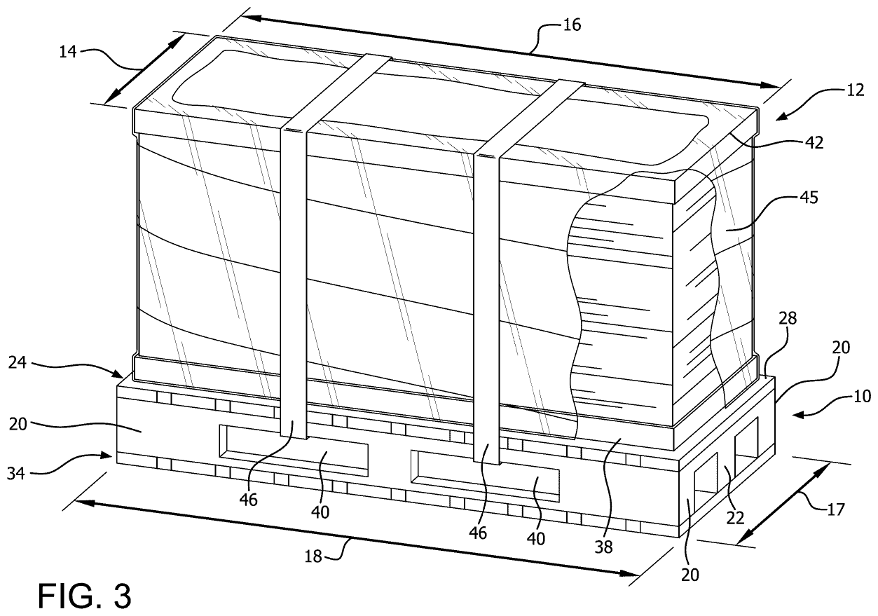

In the embodiment depicted in FIG. 1, the upper deck 28 has a width that approximately matches the width of the stack 12. Also, the upper deck 28 has a length that approximately matches the length of the stack 12. The width and length of the stack 12 are denoted by the respective arrows 14, 16 in FIG. 1. The width and length of the upper deck 28, which roughly coincide with the respective width and length of the pallet 10, are denoted by the respective arrows 17, 18 in FIG. 3.

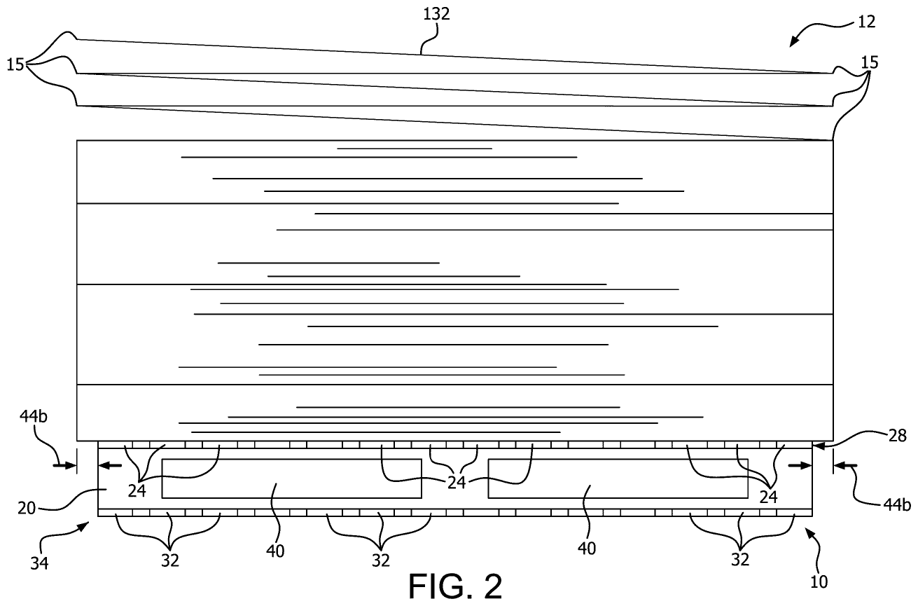

The stack 12 of fan-folded paper can be formed, for example, by folding the paper repeatedly to form a three-dimensional body. The term “three-dimensional body,” in contrast to a “two-dimensional” material (such as a sheet of flat paper), has three dimensions all of which are non-negligible. A continuous sheet 132 of the stock material, e.g., paper, can be folded at multiple fold lines 15 that extend transversely to a longitudinal direction of the continuous sheet 132, or transversely to the feed direction of the sheet 132. For example, folding a continuous sheet 132 that has a substantially uniform width along the transverse fold lines 15 can form or define individual sheet sections that have approximately the same width. The fold lines 15 are visible in FIGS. 1 and 2, which depict the uppermost sheet sections of the stack 12 unfolding as they move away from the rest of the stack 12. The continuous sheet 132 can be folded sequentially, in opposite or alternating directions, to produce an accordion-shaped continuous sheet. The individual sheet sections formed by the folding operation may be substantially rectangular or substantially square. The individual sheet sections can have other shapes in the alternative. The stack 12 is defined when the adjacent sections are folded onto and are contacting one another. The width 14 of the stack 12 coincides with the direction of the fold lines 15. The length 16 of the stack 12 coincides with the distance between sequential fold lines 15. The depth, or vertical dimension of the stack 12 coincides with a direction in which the sheet sections are stacked on one another.

The paper from which the stack 12 is formed can be configured as a single ply. Alternatively, the paper can be configured in two or more plies, so that each individual sheet section includes two or more interleaved plies (which can facilitate higher throughput on the dunnage conversion machine). The multiple plies can have the same, or different basis weights. For example, in some embodiments of a multi-ply stack 12, a first of the plies can have a basis weight between 30 lb. (30 lb. per 3,000 square feet) and 90 lb. (90 lb. per 3,000 square feet), and a second of the plies can have a basis weight within this range, but greater or less than the basis weight of the first ply. In other embodiments of a multi-ply stack 12, a first of the plies can have a basis weight of 50 lb. (50 lb. per 3,000 square feet), and a second of the plies can have a basis weight between 50 lb. and 90 lb. In other embodiments of a multi-ply stack 12, a first of the plies can have a basis weight of 50 lb., and a second of the plies can have a basis weight between 30 lb. and 50 lb. These basis weights are presented for illustrative purposes only. Alternative embodiments of multi-ply stacks 10 can include plies having basis weights outside of the above-noted ranges.

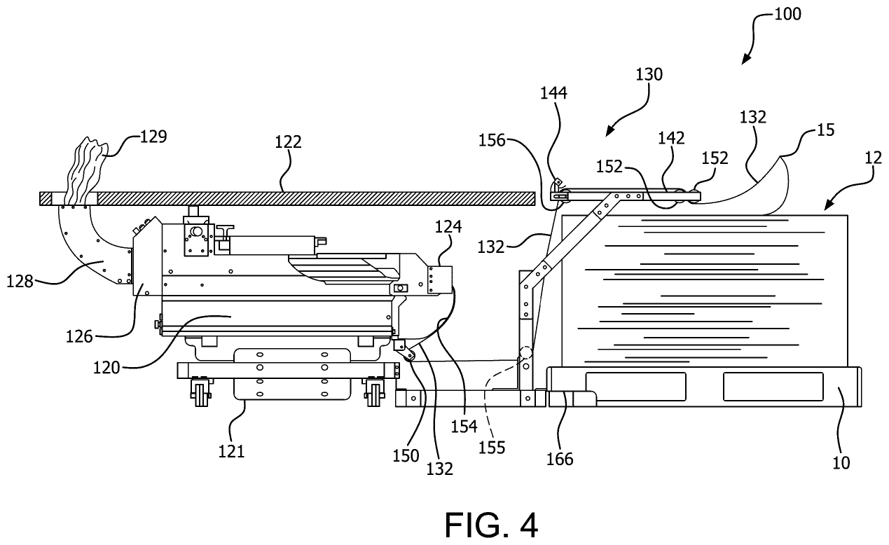

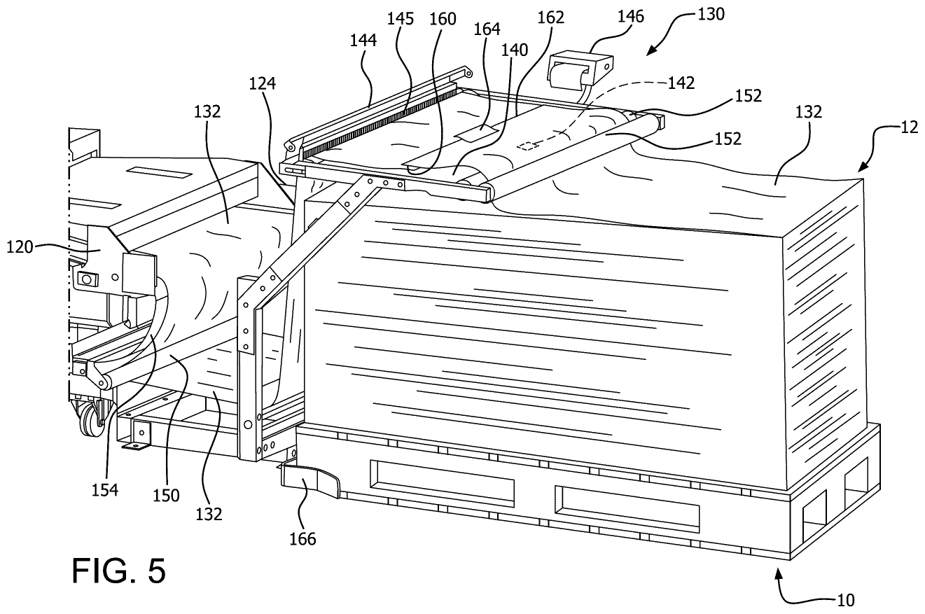

The stack 12 can be provided as any suitable number of discrete stock material units of the fan-folded stock material, with the individual units vertically stacked on one another. In some embodiments, two or more of the stacked material units can be connected together so that the stack 12 can provide a continuous material feed to the dunnage conversion machine from multiple discrete stock material units. An exemplary splicing mechanism for connecting two stacked (or unstacked) material units together is shown FIGS. 4 and 5 and is described in detail below. Also, the individual stock material units can include an attachment mechanism (not shown) that connects the multiple units of stock material within the stack 12. The attachment mechanism can be, for example, adhesive, tape, etc.

The ratio of the width 14 of the stack 12 to the length 16 of the stack 12 (referred to hereinafter as the “aspect ratio” of the stack 12) can be, for example, about 1.4:2. This aspect ratio is specified for illustrative purposes only. The aspect ratio of the stack 12 can have other values in alternative embodiments. For example, in some embodiments, the aspect ratio can be about 3:2 or less. In other embodiments, the aspect ratio can be about 1:1. In other embodiments, aspect ratio can be about 1:2. In other embodiments, the aspect ratio can be between about 1:2 and about 3:2.

A stack 12 having a width 14 of about 30 inches, a length 16 of about 40 inches, and a depth (vertical dimensions) of about 36 inches can weigh about 1,000 pounds. A stack 12 having a width 14 of about 30 inches, a length 16 of about 40 inches, and a depth of about 48 inches can weigh about 1,350 pounds. These dimensions and weights are presented for illustrative purposes only. The stack 12 can have other dimensions, and other weights in alternative embodiments.

The upper deck 28 is formed by a plurality of upper deck boards 24. In alternative embodiments, the upper deck 28 can be a closed, or solid top deck formed by a continuous sheet of wood other material.

The pallet 10 can include two outer stringers 20 that form sides of the pallet 10; and a center stringer 22. The upper deck boards 24 (or other structure forming the upper deck 28) can be mounted on, and secured to the upwardly-facing surfaces of the outer stringers 20 and the center stringer 22, with the lengthwise direction of the upper deck boards 24 being substantially perpendicular to the lengthwise direction of the outer stringers 20 and the center stringer 22. The upper deck boards 24 collectively form the upper deck 28 of the pallet 10, with the outer stringers 20 and the center stringer 22 supporting the upper deck 28. Alternative embodiments can be formed without the center stringer 22. Other alternative embodiments can be formed with stringers in addition to the outer stringers 20 and the center stringer 22.

The width and length 17, 18 of the upper deck 28 can be, for example, about 40 inches and about 48 incudes, respectively, so that the ratio of the deck width 17 to the deck length 18 is about 1.0:1.2. Alternative embodiments of the pallet 10 can have a deck width 17 greater, or less than about 40 inches, and a deck length 18 greater, or less than about 48 inches. Also, the ratio of the deck width 17 to the deck length 18 can be less than, or greater than 1.0:1.2 in alternative embodiments.

Also, the figures depict the deck width 17 as coinciding with the direction in which the upper deck boards 24 extend, and the deck length 18 as coinciding with a direction perpendicular to the direction in which the upper deck boards 24 extend. This depiction is presented for illustrative purposes only. The deck width 17 can coincide with the direction perpendicular the direction in which the upper deck boards 24 extend, and the deck length 18 can coincide with the direction in which the upper deck boards 24 extend, in the alternative.

The pallet 10 also includes a plurality of bottom deck boards 32 secured to the downwardly-facing surfaces of the outer stringers 20 and the center stringer 22, with the lengthwise direction of the lower deck boards 32 being substantially perpendicular to the lengthwise direction of the outer stringers 20 and the center stringer 22. The lower deck boards 32 collectively form a lower deck 34 of the pallet 10. The lower deck 34 is spaced from the upper deck by the outer stringers 20 and the center stringer 22. The lower deck 34 can have a width and a length that approximately match the respective width 17 and length 18 of the upper deck 28.

The upper deck boards 24 and the bottom deck boards 32 can be about 3½ inches wide and about 5/16-inch thick. The upper deck boards 24 and the bottom deck boards 32 can have other dimensions in alternative embodiments of the pallet 10.

The overall depth, or vertical dimension of the pallet 10 is about 6½ inches. The depth of the pallet 10 can have other values in alternative embodiments. The depth of the pallet 10 is denoted by the arrow 36 in FIG. 1.

The outer stringers 20 can have notches 40 formed therein to facilitate entry of the forks of a forklift between the upper deck 28 and the lower deck 32.

The upper deck 28, the lower deck 34, and the outer and center stringers 20, 22 can be formed, for example, from recycled wood. These components can be formed from other materials, such as non-recycled wood, plastic, metal, etc., in the alternative.

Specific details of the pallet 10 are presented for illustrative purposes only. Alternative embodiments of the pallet 10 can have other configurations. As another example, alternative embodiments of the pallet 10 can include one or more spacer blocks between the upper and lower decks 28, 34. In other alternative embodiments, the pallet 10 can be configured as a skid, i.e., as a type of pallet having no lower deck. In other alternative embodiments, the pallet 10 be a plastic pallet, such as a unitarily molded plastic pallet, with a closed (solid) upper deck 28, or an open (ventilated) upper deck 28.

The stack 12 of fan-folded paper rests on the upper deck 28 of the pallet 10. In some embodiments, the stack 12 can have a length 16 that is less than the length 18 of the upper deck 28. For example, the stack 12 can have a length 16 that is about 70% of the deck length 18. In such embodiments, the front and back edges of the stack 12 are offset inwardly from the respective front and side edges of the upper deck 28 by a distance denoted in FIG. 1 by the arrows 44a. In other embodiments, the stack 12 can have a length 16 that is greater than the length 18 of the upper deck 28. For example, the stack 12 can have a length 16 that is about 110% of the deck length 18. In such embodiments, the front and back edges of the stack 12 are offset outwardly from the respective front and side edges of the upper deck 28 by a distance denoted in FIG. 2 by the arrows 44b.

The offset distances 44a on either side of the stack 12 shown in FIG. 1 are depicted as being equal. The offset distances 44a can be different from each other in alternative embodiments. The offset distances 44b on either side of the stack 12 shown in FIG. 2 likewise are depicted as being equal. The offset distances 44b can be different from each other in alternative embodiments.

In other embodiments, the stack 12 can have a length 16 that is about equal to the length 18 of the upper deck 28. For example, in the embodiment depicted in FIG. 1, the width 14 of the stack 12 approximately matches the width 17 of the upper deck 28, and the length 16 of the stack 12 approximately matches the length 18 of the upper deck 28, i.e., the stack width 14 is about 100% of the deck width 17, and the stack length 16 is about 100% of the deck length 18. Thus, substantially all of the upper deck 28 can be used to support one paper stack 12, thereby eliminating the need to daisy chain or otherwise connect multiple paper stacks positioned side-by-side or end-to-end on the same pallet 10, which in turn can reduce the time and effort required to assemble one loaded pallet 10, i.e., one supply unit of fan-folded paper.

The disclosed technology is not limited to applications in which the pallet 10 accommodates only one stack 12. The disclosed technology can encompass embodiments in which the multiple stacks 12 are arranged on the upper deck 28 in an end-to-end or side-by-side arrangement. In such applications, the individual stacks 12 can be daisy-chained or otherwise connected to facilitate a continuous, i.e., non-interrupted, feed of the paper to the dunnage conversion machine from the pallet 10.

In applications where the width 14 of the stack 12 is to approximately match the width 17 of the upper deck 28, and the length 16 of the stack 12 is to approximately match the length 18 of the upper deck 28, the pallet 10 can be specifically configured so that the dimensions of the upper deck 28 are customized to match the corresponding dimensions of the stack 12. For example, in applications were the pallet 10 is to accommodate a 24-inch or 30-inch wide fan-folded stack 12, the deck width 17 of the pallet 10 can be configured at, or near 24 inches or 30 inches, respectively; and the deck length 18 can be configured at, or near the specific length 16 of the stack 12.

In applications where the stack 12 is to be used with a standard-size pallet 10, e.g., a Grocery Manufacturers Association (GMA) size pallet as discussed below, or another type of pallet 10 with predetermined dimensions, the dimensions of the stack 12 can be specifically tailored to the corresponding dimensions of the upper deck 28 of the pallet 10. In applications where the upper deck 28 of the pallet 10 is rectangular, the length 16 of the stack 12 can be tailored to the longer dimension of the pallet 10. Alternatively, the length 16 of the stack 12 can be tailored to the shorter dimension of the pallet 10 in such applications.

If desired, the stacks 12 on adjacent pallets 10 can be daisy-chained or otherwise connected to facilitate a continuous, i.e., non-interrupted, feed of the paper to the dunnage conversion machine from multiple pallets 10. Also, the relatively large footprint of the single stack 12 on the upper deck 28 of the pallet 10 can make the stack 12 more stable than multiple stacks 12 each having a smaller footprint that the stack 12, which in turn can reduce the tendency for the stack 12 to topple, allowing the depth of the stack 12, and the total amount of paper positioned on the pallet 10, to be greater than otherwise would be possible. For example, in some applications, the stack depth can be greater than 42 inches.

As noted above, in some embodiments, the stack 12 can have a length 16 that is less than the length 18 of the upper deck 28. For example, the stack 12 can have a length 16 that is at least 70% of the deck length 18. In other embodiments, the stack length 16 can be at least 80% of the deck length 18. In other embodiments, the stack length 16 can be at least 90% of the deck length 18. In other embodiments, the stack length 16 can be at least 95% of the deck length 18. In other embodiments, the stack length 16 can be at least 98% of the deck length 18.

In other embodiments, the length 16 of the stack 12 can be less than the length 18 of the upper deck 28 by about 15 inches or less, so that the offset distance 44a is about 7.5 inches or less. In other embodiments, the stack length 16 can be less than the deck length 18 by about 12 inches or less, so that the offset distance 44a is about 6.0 inches or less. In other embodiments, the stack length 16 can be less than the deck length 18 by about 6.0 inches or less, so that the offset distance 44a is about 3.0 inches or less. In other embodiments, the stack length 16 can be less than the deck length 18 by about 3.0 inches or less, so that the offset distance 44a is about 1.5 inches or less. In other embodiments, the stack length 16 can be less than the deck length 18 by about 1.5 inches or less, so that the offset distance 44a is about 0.75 inches or less.

As noted above, in some embodiments, the stack 12 can have a length 16 that is greater than the length 18 of the upper deck 28. For example, the stack 12 can have a length 16 that is at least 102% of the deck length 18. In other embodiments, the stack length 16 can be at least 105% of the deck length 18. In other embodiments, the stack length 16 can be at least 110% of the deck length 18.

In other embodiments, the length 16 of the stack 12 can be greater than the length 18 of the upper deck 28 by about 5.0 inches or less, so that the offset distance 44b is about 2.5 inches or less. In other embodiments, the stack length 16 can be greater than the deck length 18 by about 3.0 inches or less, so that the offset distance 44b is about 1.5 inches or less.

The width 14 of the stack 12 likewise can be less than, or greater than the width 17 of the upper deck 28 of the pallet 10. In embodiments where the stack width 14 is less than the deck width 17, the sides of the stack 12 are offset inwardly from the respective side edges of the upper deck 28. In embodiments where the stack width 14 is greater than the deck width 17, the sides of the stack 12 are offset outwardly from the respective side edges of the upper deck 28.

In some embodiments, the stack width 14 can be substantially less than the deck width 17, so that two or more stacks 12 can be positioned on the upper deck 28 in a side-by-side arrangement.

The pallet 10 can be, for example, a standard Grocery Manufacturers Association (GMA) size pallet 10 having an upper deck 28 with a width 14 of about 40 inches and a length 18 of about 48 inches. In this particular application, the stack 12 can have a width 14 as great as, for example, about 48 inches, and as low as, for example, about 36 inches; and a length 16 as great as, for example, about 53 inches, and as low as, for example, about 43 inches. In one possible embodiment, the width 14 and length 16 of the stack 12 can be about 39 inches and about 47 inches, respectively. In this embodiment, the sides of the stack 12 can be inwardly offset from the respective side edges of the upper deck 28 of the pallet 10 by about ½ inch, and the front and back edges of the stack 12 can be offset inwardly from the respective front and side edges of the upper deck 28 of the pallet 10 by about ½ inch, i.e., each of the offset distances 42a, 44a can be about ½ inch.

The pallet 10 can have other dimensions in alternative embodiments. For example, other standard-size pallets 10 can be used in lieu of the GMA-type pallet 10. For example, the pallet 10 can be configured as a standard 48-inch by 48-inch pallet, or a standard 42-inch by 42-inch pallet. In such embodiments where the upper deck 28 has a substantially square shape, the stack 12 have a shape that approximately matches a square, i.e., the width and length of the stack 12 can be about equal.

In other alternative embodiments, the pallet 10 can be configured as a standard (European) 800 mm by 1,200 mm pallet, etc. In this particular application, the stack 12 can have a width 14 as great as about 880 mm, and as low as about 720 mm; and a length 16 as great as about 1,320 mm, and as low as about 1,080 mm. In one possible embodiment, the width 14 and length 16 of the stack 12 can be about 750 mm and about 1,150 mm, respectively. In this embodiment, the sides of the stack 12 can be inwardly offset from the respective side edges of the upper deck 28 of the pallet 10 by about 25 mm, and the front and back edges of the stack 12 can be offset inwardly from the respective front and side edges of the upper deck 28 of the pallet 10 by about 25 mm, i.e., the offset distance 42a can be about 25 mm.

Alternative embodiments of the pallet 10 can be configured in non-standard sizes.

The palletized paper stack 12 can be assembled at one location and shipped to an end user at another location. For example, to facilitate shipping, the paper stack 12 can be positioned in a shallow tray 38 that rests directly on the upper deck 28 of the pallet 10, as shown in FIG. 3. A protective lid 42 can be placed over the top of the paper stack 12. The sides of the paper stack 12 can be wrapped with protective stretch film 45. The sides of the paper stack 12 can be wrapped with shrink wrap, a corrugated cardboard sleeve, or other protective medium in the alternative. The paper stack 12 can be secured to the pallet 10 with bands 46 or other types of ties. The bands 46 can be wrapped around the paper stack 12 in a direction corresponding to the width 17 of the paper stack 12, as shown in FIG. 3. The bands 46 can be wrapped around the paper stack 12 along the length 18 of the paper stack 12 in the alternative. Less, or more than two of the bands 46 can be used to secure the paper stack 12 in the alternative. Also, the bands 46 are shown as extending through the notches 40 in the pallet 10. The bands 46 can wrap around the bottom of the pallet 10 in the alternative. The protective stretch film 45 can be wrapped around the paper stack 12 beneath the bands 46, as shown in FIG. 3. The stretch film 45 can be wrapped over the bands 42 in the alternative. In some applications, edge or corner protectors (not shown) can be applied to paper stack 12.

The above details relating to the packaging and securement of the paper stack 12 on the pallet 10 are presented for exemplary purposes only. The paper stack 12 can be packaged and secured in other ways in the alternative.

FIGS. 4 and 5 depict an exemplary splicing unit 130 for connecting two of the stacked material units together. The splicing unit 130 is depicted as part of a system 100 for converting stock material to dunnage. In addition to the splicing unit 130, the system 100 includes a protective packaging machine 120 and a work surface 122. The system 100 may be arranged at a workstation of an operator who operates the protective packaging machine 120, commonly referred to as a conversion machine (or dunnage conversion machine), to dispense protective packaging material.

The splicing unit 130 and the remainder of the system 100 are described for illustrative purposes only. The supply units made-up of the stack 12 and the pallet 10, and variants thereof, can be used in other applications, including in conjunction with other types of systems for converting stock material to dunnage, and in other applications that do not require or otherwise involve splicing the stock material of multiple supply units together.

The protective packaging machine 120 includes an inlet 124 and an outlet 126, and is configured to convert dunnage from a supply of the fan-folded stock material contained in the stack 12 of the supply unit. The fan-folded paper is fed into the protective packaging machine 120 via the inlet 124. As shown in FIGS. 4 and 5, the protective packaging machine 120 may be arranged underneath a table, and optionally may be supported by a platform 121.

The horizontal surface of the table is defined by the work surface 122, and the work surface 212 may be used by an operator to receive finished paper products, e.g., pads 129, that are routed from the outlet 126 of the protective packaging machine 120 via a chute 128. The pads can be used as packaging materials, for example, for loading into packages by the operator situated at the workstation. In particular, the operator may load finished pads 129 into a separate container such as a cardboard box (not shown) for cushioning one or more items contained in the cardboard box. The work surface 122 of the table includes an opening for receiving the pads 129 that exit the protective packaging machine 120 via the outlet 126.

The splicing unit 130 is defined by a splicing support surface 140, e.g., a flat, horizontal support surface arranged on the splicing unit 130. At a minimum, the splicing support surface 140 serves as a backing surface that may contact the continuous sheet of stock material 132 being unfolded and pulled from the stack 12 of the unit of stacked material unit during operation of the protective packaging machine 120. The splicing support surface 140 is configured to provide a backing for allowing the operator to carry out a splicing operation once the protective packaging machine 120 is slowed or stopped. The splicing support surface 140 can have an orientation other than horizontal, and a shape other than flat in the alternative. The splicing unit 130 is configured to allow for splicing a new supply unit of stock material when the existing supply unit is depleted or nearly depleted. The splicing support surface 140 can have a width that is greater than or equal to the width of the sheet of stock material 132 that passes through splicing rollers 152 at a first end, i.e., a proximal end or upstream end, of the splicing unit 130. The splicing unit 130 can include one or more splicing rollers 156 at a second end, i.e., a distal end or downstream end, of the splicing unit 30. In come embodiments, a single splicing roller 156 may be configured to receive the stock material between a brake 144 and a single splicing roller 156, as described herein. Alternatively, it is possible for the splicing support surface 140 to have a width that is smaller than a width of sheet of stock material 132 received at the splicing unit 130, depending on the arrangement of the splicing rollers 152 and/or the splicing rollers 156.

As shown in FIG. 5, a dispenser 146 or supply of splicing elements (also referred to as splicing members, or splices) may be arranged adjacent to the splicing support surface 140. For example, the dispenser 146 may be arranged on a platform that is connected to the table and/or the splicing unit 130. Alternatively, the dispenser 146 may be a stand-alone device positioned near or adjacent to the splicing unit 130. The splicing elements dispensed by the dispenser 146 may include adhesive or cohesive-based elements, and may be a single-sided tape, double-sided tape, a cohesive, an element with a release layer, a sticker, or any other suitable splicing mechanism. The splicing elements can include discrete, pre-cut elements, and/or a roll of tape of indeterminate length for allowing the operator to form a splice of a desired length. The splicing elements may be dispensed manually from the dispenser 146, or automatically upon actuation of a sensor 142 arranged on the splicing unit 130. Alternatively, the web of paper itself, i.e., the stock material within the stack 12, may include a release layer that can be peeled off to expose an adhesive or cohesive, which may be used to facilitate splicing to another web of paper.

The splicing unit 130 is operably connected to the protective packaging machine 120. The splicing unit 130 includes the splicing support surface 140, the sensor 142, and the brake 144. The splicing support surface 140 is configured to receive the sheet of stock material 132 from the supply unit of stock material prior to the sheet 132 being routed to the protective packaging machine 120. In particular, a leading end of the sheet 132 may be threaded through the splicing rollers 152 and 156, thus passing over the splicing support surface 140, and thereafter be nipped by a set of rollers 155 arranged between the splicing unit 130 and the protective packaging machine 120. The protective packaging machine 120 is arranged downstream of the splicing unit 130, and includes rollers 150 and a guide 154 for feeding the sheet 132 into the protective packaging machine 120.

The sensor 142 can be associated with the splicing unit 130 and, for example, may be fixed to the splicing unit 130 provided adjacent thereto. The sensor 142 is configured to detect when the supply unit of stock material is depleted. For example, the sensor 142 may be configured to detect when a trailing end of the sheet of stock material 132 passes over the splicing unit 130.

Once the sensor 142 detects that the supply of stock material has been depleted, or the sensor 142 detects that there is an absence of a sheet of stock material 132, the sensor 142 may cause the protective packaging machine 120 to shift into stand-by mode or otherwise stop, e.g., by actuating a shutdown switch, thus suspending conversion of the stock material. In some embodiments, the sensor 142 is connected to a controller (not shown) that is operably connected to the protective packaging machine 120 and stops the protective packaging machine 120 from operating. Alternatively, the sensor 142 may trigger a gradual shutdown of the protective packaging machine 120, e.g., after a delay of about 1 to 3 seconds. As a further alternative, the sensor 142 may simply slow down operation of the protective packaging machine 120 to provide the operator with sufficient time to perform a splicing operation on the splicing support surface 140.

The sensor 142 may be operable to cause the supply of stock material to stop or slow down at the splicing unit 130, typically on the splicing support surface 140. The stock material can be slowed, stopped, and/or held by the brake 144, which is a mechanical element configured to engage the sheet of stock material 132 that moves over the splicing support surface 140.

Referring to FIG. 5, the brake 144 may be in the form of a brush including a series of bristles 145 that are fixed to a metal support made of, for example, aluminum, where the bristles 145 are arranged transversely along the brake 144 in order to gently engage the sheet of stock material 132 while allowing the sheet 132 to pass through the splicing unit 130.

The brake 144 may be configured to stop the sheet 132 from moving without damaging the stock material, for example, by applying pressure via the bristles 145 of the brake 144. The bristles 145 are configured to deflect and gently apply pressure, thereby holding the stock material in place. For example, the bristles 145 may be formed of a stiff material that resiliently retains the bristles 145 in a straight position. In this way, when the bristles 145 are pushed into the trailing end of the sheet 132, they deflect with enough force to hold the sheet 132 in place. Alternatively, additional pressure can be applied via a spring or other device. Instead of a brush with bristles 145, the brake 144 may be any other device or structure capable of stopping movement of the stock material at the splicing unit 130.

The pallet 10 may be held in place relative to the splicing unit 130 by a positioning device in the form of a fork 166, which serves as a guide to receive the pallet 10. Other suitable positioning devices, such as a movable platform, may be used to hold the pallet 10 in place as the stock material is converted.

The stock material can be stopped at the splicing support surface 140. The splicing support surface 140 is configured to provide a suitable surface to splice, daisy-chain, connect, etc., a new supply unit of stock material to the stock material that has been depleted as detected by the sensor. Referring to FIG. 5, the brake 144 is depicted as holding the sheet of stock material 132 relative to the splicing support surface 140 after a trailing end 160 the sheet 132 has passed the sensor 142. The leading end 162 of a new sheet of stock material 132 is shown schematically being spliced via a splicing member 164 to the trailing end 160 of the depleted supply of stock material such that a continuous supply of stock material is routed to the protective packaging machine 120 when a new supply of stock material is being loaded or used, without the need for routing the new supply of stock material into the protective packaging machine 120. Optionally, an additional brake (similar to the brake 144) may be provided at the first end (upstream end, proximal end) of the splicing support surface 140 to hold the new sheet of stock material 132 that is being spliced in place so that it does not slip during the splicing operation. In some embodiments, the splicing member 164 may be dispensed by the dispenser 146 arranged at or near the splicing support surface 140 to be easily accessible by an operator who is undertaking the splicing operation on the splicing support surface 140.

The splicing support surface 140 is depicted as being located above the supply of stock material, which allows for the supply of stock material to easily be routed into the splicing unit 130 for splicing as discussed above. In other embodiments, the splicing support surface 140 can be positioned at other locations. The splicing support surface 140 is configured to allow ergonomic and convenient splicing of a depleted supply to a new supply of stock material. The supplies of stock material can be spliced using any suitable method such as adhesive, cohesive, or any other suitable splicing mechanism.

The trailing end 160 of the sheet of stock material 132 is configured to be spliced to the leading end 162 of a new sheet of stock material 132. The trailing end 160 and leading end 162 are held together by the splicing member 164. The splicing member 164 is depicted as being positioned at a central location to transversely connect the leading end 162 and the trailing end 160. The splicing member 164 can be positioned anywhere along transverse edges of the trailing and leading ends 160, 162 in the alternative, and may be positioned in a plurality of locations. In applications where the supply of stock material includes multiple plies, a splicing member 164 may be configured to extend from edge to edge on the interior or exterior of the plies of the leading or trailing end, depending on the desired configuration. The plies may sandwich the splicing members on the exterior or interior depending on where the splicing member is positioned. The sheet material may be spliced in any known configuration including, for example, a configuration with the splicing member only on the center of the leading or trailing end of the stock material, or with the splicing member only on the edges of the leading or trailing end of the stock material.

The protective packaging machine 120 preferably converts one or multiple plies of, for example, paper-based stock material, i.e., high-density paper, into a lower-density pad. For example, the multiple plies may be held together by a zipper formed by the protective packaging machine 120. The protective packaging machine 120 can include a separating/cutting device having a blade, and can be configured to separate or cut the packaging articles prior to the packaging articles entering the work surface 122. The work surface 122 is arranged at the outlet 126 of the protective packaging machine 120 downstream of the blade of the separating/cutting device. An operator can receive the separated or cut packaging articles, e.g., the pads 129, at the work surface 122 and can arrange one or more of the pads 129 for packaging purposes. Referring to FIG. 4, a pad 129 exits the chute 128 after being cut by the cutting device that is part of the protective packaging machine 120, and may have a predetermined length and thickness. The work surface 122 can be configured as a table positioned over the protective packaging machine 120. The support surface 140 can be positioned at approximately the same height as the work surface 122 for the convenience of the operator. The support surface 140 can be positioned above or below the work surface 122 in other applications.

As discussed above, after being routed through the splicing unit 130, the sheet of stock material 132 is routed to the protective packaging machine 120, which can be located upstream of the protective packaging machine 120. The splicing unit 130 includes the splicing rollers 152, 156 arranged at opposite ends of the splicing support surface 140. The splicing rollers 152 route the sheet 132 through the splicing unit 130 and to the protective packaging machine 120. The system 100 can include rollers 155 arranged between the splicing unit 130 and the protective packaging machine 120. The protective packaging machine 120 includes packaging unit rollers 150 that route the sheet 132 from the splicing unit 130 and/or the rollers 155 and into the protective packaging machine 120. The protective packaging machine 120 can include a guide 154 that is configured to gently guide the sheet 132 into the protective packaging machine 120.

After the trailing end 160 of the sheet of stock material 132 has passed over the sensor 142, the protective packaging machine 120 may be operated to stop or slow production of dunnage material, and the brake 144 is configured to gently hold the sheet 132 so as to prevent the supply of stock material from traveling over the splicing support surface 140. This allows the trailing end 160 to be spliced via the splicing member 164 to the leading end 162 of a new sheet of stock material 132 as depicted in FIG. 5, facilitated a continuous flow of stock material through the dunnage conversion machine 120 and ergonomic splicing of the stock material. As discussed above, a brake other than, or in addition to the brake 144 can used to hold the leading end 162 in place.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A palletized unit of fan-folded stock material, comprising:
a pallet that includes a deck configured to support the fan-folded stock material, the deck having a deck length and a deck width; and
a first stack of the stock material supportively positioned on the deck, which stock material includes an elongated web of sheet material configuration defined by folds in the web about fold lines that extend in a transverse direction of the web that segment the web into a plurality of sheet sections, with adjacent sheet sections folded onto one another, the first stack having:
a transverse stack width measured in a transverse direction coinciding with the transverse direction of the stack,
a stack length measured in a lengthwise direction coinciding with a longitudinal spacing between sequential folds, and
a stack depth coinciding with a direction in which the sheet sections are stacked on one another;
wherein the first stack is positioned on the deck with the stack length and stack width generally aligned with the deck length and the deck width, respectively, and the stack length is about equal to or greater than 70% of the deck length.

2. The palletized unit of claim 1, wherein the stack length is greater than 70% of the deck length and less than 110% of the deck length.

3. The palletized unit of claim 1, wherein the stack length is about equal to or greater than 100% of the deck length.

4. The palletized unit of claim 1, wherein the first stack has an aspect ratio of the stack width to the stack length, which aspect ratio is less than about 3:2.

5. The palletized unit of claim 1, wherein the deck width and the deck length are within about five percent of each other.

6. The palletized unit of claim 1, wherein the stock material is paper.

7. The palletized unit of claim 1, wherein the elongated web of sheet material includes a first ply and a second ply of the stock material superimposed on each other so that each of the folds in the first ply corresponds to a respective fold in the second ply.

8. The palletized unit of claim 7, wherein a basis weight of the first ply is different than a basis weight of the second ply.

9. The palletized unit of claim 7, wherein the first ply has slits formed therein.

10. The palletized unit of claim 9, wherein:
the second ply has slits formed therein; and
a size, an orientation, and/or a pattern of the slits in the first ply are different than a size, an orientation, and/or a pattern of the slits in the second ply.

11. The palletized unit of claim 7, wherein each of the plurality of sheet sections includes a portion of the first ply and a portion of the second ply in an interleaved arrangement.

12. The palletized unit of claim 1, further comprising:
one or more ties wrapped around the first stack and secured to the pallet;
a cover positioned over the first stack; and/or
a tray positioned between the deck and the first stack.

13. The palletized unit of claim 1, further comprising a protective medium positioned around the first stack.

14. The palletized unit of claim 1, wherein the first stack of the stock material is free of splices within the first stack of the stock material.

15. The palletized unit of claim 1, further comprising a second stack of the stock material supportively positioned on the deck in a side-by-side relationship with the first stack so that the stack length and stack width of the second stack are generally aligned with the stack length and stack width of the first stack, wherein the web of the second stack is connected to the web of the first stack by a splice between the webs of the first and second stacks.

16. A palletized unit of fan-folded stock material, comprising:
a pallet that includes a deck configured to support the fan-folded stock material, the deck having a deck length and a deck width; and
a first stack of the stock material supportively positioned on the deck, which stock material includes an elongated web of sheet material configuration defined by folds in the web about fold lines that extend in a transverse direction of the web that segment the web into a plurality of sheet sections, with adjacent sheet sections folded onto one another, the first stack having:
a stack width coinciding with the transverse direction of the stack,
a stack length coinciding with a longitudinal spacing between sequential folds,
a stack depth coinciding with a direction in which the sheet sections are stacked on one another, and
an aspect ratio of the stack width to the stack length;
wherein the first stack is positioned on the deck with the stack length and stack width generally aligned with the deck length and the deck width, respectively, and
wherein the aspect ratio of the stack width to the stack length is less than about 3:2.

17. The palletized unit of claim 16, wherein the aspect ratio of the stack width to the stack length is between about 1:2 and about 3:2.

18. The palletized unit of claim 16, wherein the fan-folded stock material is paper.

19. A system for converting stock material to dunnage, comprising;
the palletized unit of claim 1; and
a dunnage conversion machine configured to deform the stock material from a first configuration to a lower-density second configuration.

20. A method for producing dunnage, comprising:
providing a palletized unit of fan-folded stock material, the palletized unit of fan-folded stock material including:
a pallet that includes a deck configured to support the fan-folded stock material; and
a supply of the stock material supportively positioned on the deck, which stock material includes a single elongated web of sheet material configuration defined by folds in the web about fold lines that extend in a transverse direction of the web that segment the web into a plurality of sheet sections, with adjacent sheet sections folded onto one another, the web of sheet material being free of splices;
providing a dunnage conversion machine configured to deform the stock material from a first configuration to a lower-density second configuration; and
feeding an entirety of the supply of the web of sheet material from the pallet and to the dunnage conversion machine.
